(19) United States
(12) Patent Application Publication
(10) Pub. No.: US 2020/0033657 A1
(43) Pub. Date: Jan. 30, 2020

(54) DISPLAY PANEL AND METHOD OF MANUFACTURING THE SAME

(71) Applicants: HKC Corporation Limited, Baoan Dist, Shenzhen (CN); Chongqing HKC Optoelectronics Technology Co., Ltd., Chingqing (CN)

(72) Inventor: YU-JEN CHEN, Chongqing (CN)

(21) Appl. No.: 15/740,356

(22) PCT Filed: Oct. 16, 2017
(86) PCT No.: PCT/CN2017/106306

§ 371 Date: Dec. 28, 2017

(30) Foreign Application Priority Data
Jul. 6, 2017 (CN) 201710546034.4

(51) Int. Cl. G02F 1/1339; G02F 1/1345; G02F 1/1362

(52) U.S. Cl. CPC G02F 1/13394; G02F 1/13454; G02F 2202/022; G02F 1/136286; G02F 2001/13398; G02F 1/13452

(57) ABSTRACT

A display panel and a method for manufacturing the same are provided. The display panel includes a first substrate, a second substrate including a color filter layer and disposed opposite to the first substrate, and a liquid crystal layer disposed between the first substrate and the second substrate. The first substrate includes a circuit area and a display area. The circuit area is formed with a spacer layer, a dielectric constant of the spacer layer is lower than a dielectric constant of the liquid crystal layer.

### CROSS-REFERENCE TO RELATED APPLICATION

This application claims the benefit of China Patent Application No. 201710546034.4, filed on Jul. 6, 2017, in the State Intellectual Property Office of the People's Republic of China, the disclosure of which is incorporated herein in its entirety by reference.

### FIELD OF THE INVENTION

The present invention relates to the display technology, and more particularly to a display panel for reducing the resistance-capacitance load of a circuit and a method for manufacturing the same.

### BACKGROUND OF THE INVENTION

With the development and progress of science and technology, a liquid crystal display has the advantages of a thin body, energy-saving, no radiation and so on, and thus becomes the mainstream of the display products and widely used. Most of the liquid crystal displays on the market are of the backlight-type, which includes a liquid crystal panel and a backlight module. The liquid crystal panel includes two parallel glass substrates and liquid crystals disposed between the two parallel glass substrates. The two glass substrates are applied with a driving voltage for controlling the direction of rotation of the liquid crystals to reflect the light from the backlight module so as to produce a picture.

A thin film transistor liquid crystal display (TFT-LCD) is now in a dominant position in the display field because of its low power consumption, excellent picture quality, high production yield, and other performances. Similarly, the thin film transistor liquid crystal display includes a liquid crystal panel and a backlight module. The liquid crystal panel includes a color filter substrate (CF substrate), a thin film transistor substrate (TFT substrate), and a mask. A transparent electrode is provided between opposite inner sides of the two substrates. A layer of liquid crystals is sandwiched between the two substrates.

With regard to the thin Film Transistor-Liquid Crystal Display (TFT-LCD), in order to highlight the overall picture of the screen, the design of narrow borders and no borders gradually become an important development direction of liquid crystal display. In the realization of the design of narrow borders and no borders, it is possible to reduce the generation cost, and it is the pursuit of technical person in the field.

Conforming to this trend, Gate Driver on Array (GOA) circuit has been widely used. The GOA circuit is fabricated at the same time as the first substrate in-plane structure by the same film-forming method as the semiconductor device such as the in-plane liquid crystal driving switch. Its appearance eliminates the need for the cost of scanning the line-driven chip and eliminates the need to solder the flexible circuit board (FPC) to the edge of the Liquid Crystal Display panel. GOA circuit not only makes the control and design of the liquid crystal display more convenient, but also greatly reduces the width of the frame of the liquid crystal display.

But GOA technology has some temporary problems cannot be appropriately solved, for example, the resistance-capacitance load of the relevant circuit is too large.

It should be noted that the above description of the background is merely provided for clear and complete explanation of the present disclosure and for easy understanding by those skilled in the art. And it should not be understood that the above technical solution is known to those skilled in the art as it is described in the background of the present disclosure.

### SUMMARY OF THE INVENTION

In view of the above-mentioned drawbacks of the prior art, the primary object of the present disclosure is to provide a display panel and a method for manufacturing the same capable of slowing down and reducing the resistance-capacitance load of the circuit.

To achieve the above objectives, the present invention provides a display panel for reducing the resistance-capacitance load of a circuit and a method for manufacturing the same, the display panel includes: a first substrate; a second substrate including a color filter layer and disposed opposite to the first substrate; a liquid crystal layer disposed between the first substrate and the second substrate; wherein the first substrate includes a circuit area and a display area; the circuit area is formed with a spacer layer, a dielectric constant of the spacer layer is lower than a dielectric constant of the liquid crystal layer; the circuit area includes: a driving area integrated with the gate driving chip; and a lead area for transmitting a signal of the driving area to a scanning line in the display area; the spacer layer is disposed between the first substrate and the second substrate corresponding to the driving area and the lead area, respectively; the spacer layer includes a polystyrene material.

The present invention further provides a method for manufacturing a display panel, the method including the steps of: providing a first substrate; providing a second substrate disposed opposite to the first substrate; forming a color filter layer on the second substrate; disposing a liquid crystal layer between the first substrate and the second substrate; exposing a periphery of a display area of the first substrate to form a circuit area; disposing a spacer layer between the first substrate and the second substrate corresponding to the circuit area, a dielectric constant of the spacer layer is lower than that of the liquid crystal layer.

In the present invention, since the spacer layer having a dielectric constant lower than that of the liquid crystal layer is provided at a portion corresponding to the circuit area between the first substrate and the second substrate. According to the parallel capacitance formula, it is known that C=εA/d, and the dielectric constant of the spacer layer is lower than that of liquid crystal layer, it can be seen that the overall capacitance at the circuit area will be effectively reduced after the setting, and thus to alleviate the problem that the resistance-capacitance load is too large.

With reference to the following description and drawings, the particular embodiments of the present disclosure are disclosed in detail, and the principle of the present disclosure and the manners of use are indicated. It should be understood that the scope of the embodiments of the present disclosure is not limited thereto. The embodiments of the present disclosure contain many alternations, modifications and equivalents within the spirits and scope of the terms of the appended claims.

Features that are described and/or illustrated with respect to one embodiment may be used in the same way or in a similar way in one or more other embodiments and/or in combination with or instead of the features of the other embodiments.

It should be emphasized that the term “includes/including” when used in this specification is taken to specify the presence of stated features, integers, steps or components but does not preclude the presence or addition of one or more other features, integers, steps, components or groups thereof.

### BRIEF DESCRIPTION OF THE DRAWINGS

The drawings are included to provide further understanding of the present disclosure, which constitute a part of the specification and illustrate the preferred embodiments of the present disclosure, and are used for setting forth the principles of the present disclosure together with the description. It is obvious that the accompanying drawings in the following description are some embodiments of the present disclosure only, and a person of ordinary skill in the art may obtain other accompanying drawings according to these accompanying drawings without making an inventive effort. In the drawings:

FIG. 1 is a schematic view of a display panel of the present invention;

FIG. 2 is a schematic view of a display panel in accordance with an embodiment of the present invention;

FIG 3 is a schematic view of a display panel in accordance with another embodiment of the present invention;

FIG. 4 is a configuration diagram corresponding to the embodiment shown in FIG. 2;

FIG. 5 is a configuration diagram corresponding to the embodiment shown in FIG. 3;

FIG 6 is a flow chart of a method for manufacturing a display panel of the present invention.

### DESCRIPTION OF THE PREFERRED EMBODIMENTS

In order to make a better understanding of the technical solutions in the present application to those skilled in the art, the technical solutions in the embodiments of the present application will be described clearly and completely with reference to the drawings in the embodiments of the present application. Apparently, the embodiments described are merely partial embodiments of the present application, rather than all embodiments. Other embodiments figured out by those skilled in the art on the basis of the embodiments of the invention without going through creative efforts shall all fall within the protection scope of the present application.

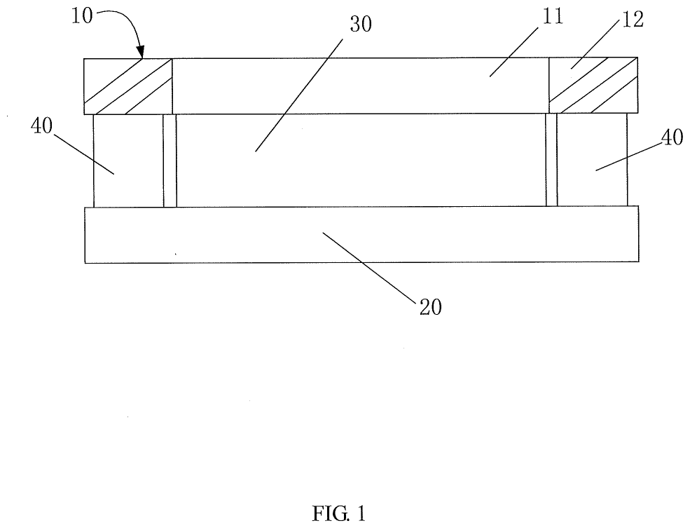

FIG. 1 is a schematic view of a display panel of the present invention for reducing the resistance-capacitance load of a circuit, the display panel includes:

A first substrate 10;

A second substrate 20 includes a color filter layer (not shown in figure) and be disposed opposite to the first substrate 10;

A liquid crystal layer 30 is disposed between the first substrate 10 and the second substrate 20;

The first substrate 10 includes a circuit area 12 and a display area 11 provided in correspondence with the liquid crystal layer 30;

A spacer layer 40 is formed on the circuit area 12, a dielectric constant of the spacer layer 40 is lower than a dielectric constant of the liquid crystal layer 30.

Optionally, the circuit area 12 is GOA circuit area; the spacer layer 40 is filled with a low dielectric material.

In the present invention, the spacer layer having a dielectric constant lower than that of the liquid crystal layer is provided at a portion corresponding to the circuit area between the first substrate and the second substrate. According to the parallel capacitance formula, it is known that C=εA/d, and the dielectric constant of the spacer layer is lower than that of liquid crystal layer, it can be seen that the overall capacitance at the circuit area will be effectively reduced after the setting, and thus to alleviate the problem that the resistance-capacitance load is too large.

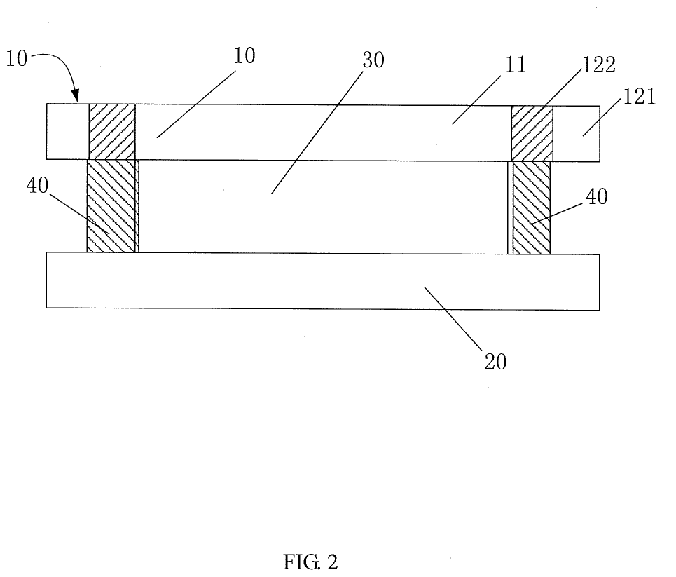

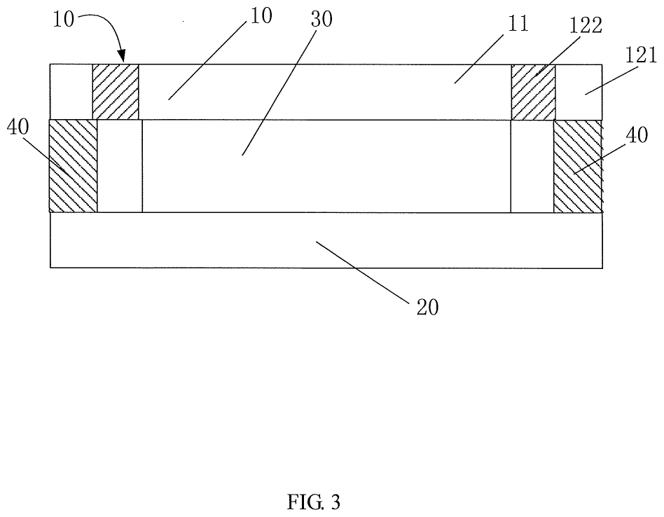

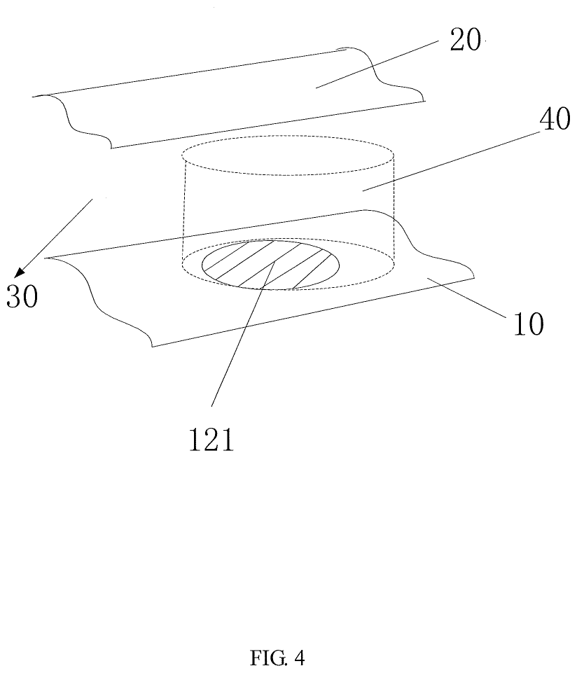

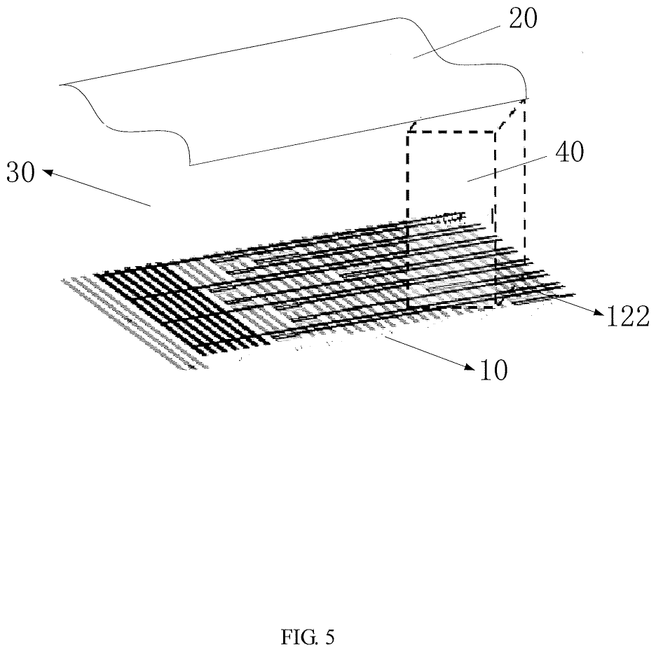

FIG. 2 is a schematic view of a display panel in accordance with an embodiment of the present invention, FIG. 3 is a schematic view of a display panel in accordance with another embodiment of the present invention, FIG. 4 is a configuration diagram corresponding to the embodiment shown in FIG. 2, and FIG. 5 is a configuration diagram corresponding to the embodiment shown in FIG. 3. Referring to FIGS. 2 to 5, with reference to FIG. 1:

In this embodiment, the circuit area 12 includes:

A driving area 121 is integrated with the gate driving chip; and

A lead area 122 transmits a signal of the driving area 121 to a scanning line in the display area 11;

The spacer layer 40 is disposed between the first substrate 10 and the second substrate 20 corresponding to the driving area 121. Specifically, a cross-sectional shape of the spacer layer 40 corresponds to a shape of the driving area 121.

The capacitor of the circuit area includes a starting capacitor (Cd_com), and the starting capacitor (Cd_com) is mainly present in the driving area. In the present invention, the spacer layer having a dielectric constant lower than that of the liquid crystal layer is provided at a portion corresponding to the driving area between the first substrate and the second substrate. According to the parallel capacitance formula, it is known that C=εA/d, and the dielectric constant of the spacer layer is lower than that of liquid crystal layer. It can be seen that capacitance of the driving area is reduced, so that the overall capacitance at the circuit area will be effectively reduced after the setting, and thus to alleviate the problem that the resistance-capacitance load is too large.

In this embodiment, the circuit area 12 includes:

A driving area 121 is integrated with the gate driving chip; and

A lead area 122 transmits a signal of the driving area 121 to a scanning line in the display area 11;

The spacer layer 40 is disposed between the first substrate 10 and the second substrate 20 corresponding to the lead area 122. Specifically, a cross-sectional shape of the spacer layer 40 corresponds to a shape of the lead area 122. The capacitor of the circuit area includes a gate-drain capacitance (Cgd), and the gate-drain capacitance (Cgd) is mainly present in the lead area. In the present invention, the spacer layer having a dielectric constant lower than that of the liquid crystal layer is provided at a portion corresponding to the lead area between the first substrate and the second substrate. According to the parallel capacitance formula, it is known that C=εA/d, and the dielectric constant of the spacer layer is lower than that of liquid crystal layer. It can be seen that capacitance of the lead area is reduced, so that the overall capacitance at the circuit area will be effectively reduced after the setting, and thus to alleviate the problem that the resistance-capacitance load is too large.

In this embodiment, the circuit area 12 includes:

A driving area 121 is integrated with the gate driving chip; and

A lead area 122 transmits a signal of the driving area 121 to a scanning line in the display area 11;

The spacer layer 40 is disposed between the first substrate 10 and the second substrate 20 corresponding to the driving area 121 and the lead area 122. Specifically, a cross-sectional shape of the spacer layer 40 corresponds to an overall shape of the driving area 121 and the lead area 122. The capacitor of the circuit area includes a starting capacitor (Cd_com) and a gate-drain capacitance (Cgd), and the starting capacitor (Cd_com) is mainly present in the driving area, and the gate-drain capacitance (Cgd) is mainly present in the lead area. In the present invention, the spacer layer having a dielectric constant lower than that of the liquid crystal layer is provided at a portion corresponding to the driving area and the lead area between the first substrate and the second substrate. According to the parallel capacitance formula, it is known that C=εA/d, and the dielectric constant of the spacer layer is lower than that of liquid crystal layer. It can be seen that the capacitance of the driving area and the lead area are reduced, so that the overall capacitance at the circuit area will be effectively reduced after the setting, and thus to alleviate the problem that the resistance-capacitance load is too large.

The design of the width of the spacer layer described above can be matched to the size of the corresponding driving area, lead area, or circuit area as much as possible. Of course, it may be slightly larger and smaller, as long as the spacer layer is compatible with the structure of the product.

In this embodiment, optionally, a spacing support unit (not shown in figure) is disposed between the first substrate 10 and the second substrate 20, the spacer layer 40 is made of the same material as the spacing support unit. Meanwhile, the spacer layer 40 includes a polystyrene material (PS material which can be used in a liquid crystal panel, and can be used as a manufacturing material for the spacing support unit, i.e., a PS/photo spacer, which is the material of the spacing support unit). The polystyrene material, in most cases, has a dielectric constant lower than 3 and also lower than the dielectric constant of the liquid crystal layer. The polystyrene material, is used as the filler corresponding to the circuit area, and can effectively reduce the overall dielectric constant, thereby reducing the capacitance here, and thus to alleviate the problem that the resistance-capacitance load is too large. The spacer layer has a variety of materials to choose from, such as a low dielectric constant material based on a silicon-based polymer or carbon-doped silicon oxide, but also by reducing the polarity of the material itself and increase the void density in the material, thereby reducing the molecular density of materials and other methods to achieve. The polystyrene material, not only its dielectric constant conforms to the requirements of this case, but also the technology is mature and can be used quickly, and the cost is relatively low. In addition, the polystyrene material can be used not only to effectively alleviate the problem that the resistance-capacitance load is too large, but also as a support between the first substrate and the second substrate. In addition, it can also serve as an auxiliary sealing material, sealing the liquid crystal layer (in fact, including the active switch layer, polarizing layer, etc.) at both ends.

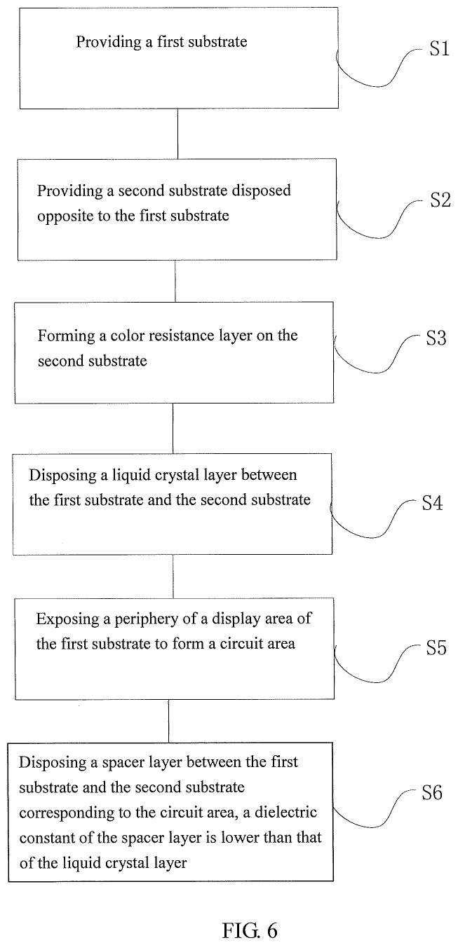

FIG. 6 is a flow chart of a method for manufacturing a display panel of the present invention, the method including the steps of:

S1: providing a first substrate;

S2: providing a second substrate disposed opposite to the first substrate;

S3: forming a color filter layer on the second substrate;

S4: disposing a liquid crystal layer between the first substrate and the second substrate;

S5: exposing a periphery of a display area of the first substrate to form a circuit area;

S6: disposing a spacer layer between the first substrate and the second substrate corresponding to the circuit area, a dielectric constant of the spacer layer is lower than that of the liquid crystal layer.

The GOA product obtained by the well-known method has a problem that the resistance-capacitance load is too large. The reason is that the capacitor at GOA is too large to cause the resistance-capacitance load to be large, if it can effectively reduce the capacitor of the circuit area, the load problem can also be effectively alleviated; In the present invention, the spacer layer having a dielectric constant lower than that of the liquid crystal layer is provided at a portion corresponding to the circuit area between the first substrate and the second substrate. According to the parallel capacitance formula, it is known that C=εA/d, and the dielectric constant of the spacer layer is lower than that of liquid crystal layer, it can be seen that the overall capacitance at the circuit area will be effectively reduced after the setting, and thus to alleviate the problem that the resistance-capacitance load is too large.

In this embodiment, the step of forming the circuit area includes forming a driving area integrated with the gate driving chip function, and a lead area transmitting a signal of the driving area to a scanning line in the display area;

The spacer layer is disposed between the first substrate and the second substrate corresponding to the driving area. Specifically, the spacer layer is disposed corresponding to the driving area, a cross-sectional shape of the spacer layer corresponds to a shape of the driving area. The capacitor of the circuit area includes a starting capacitor (Cd_com), and the starting capacitor (Cd_com) is mainly present in the driving area. In the present invention, the spacer layer having a dielectric constant lower than that of the liquid crystal layer is provided at a portion corresponding to the driving area between the first substrate and the second substrate. According to the parallel capacitance formula, it is known that C=εA/d, and the dielectric constant of the spacer layer is lower than that of liquid crystal layer. It can be seen that capacitance of the driving area is reduced, so that the overall capacitance at the circuit area will be effectively reduced after the setting, and thus to alleviate the problem that the resistance-capacitance load is too large.

In this embodiment, the step of forming the circuit area includes forming a driving area integrated with the gate driving chip function, and a lead area transmitting a signal of the driving area to a scanning line in the display area.

The spacer layer is disposed between the first substrate and the second substrate corresponding to the lead area. Specifically, the spacer layer is disposed corresponding to the lead area, a cross-sectional shape of the spacer layer corresponds to a shape of the lead area. The capacitor of the circuit area includes a gate-drain capacitance (Cgd), and the gate-drain capacitance (Cgd) is mainly present in the lead area. In the present invention, the spacer layer having a dielectric constant lower than that of the liquid crystal layer is provided at a portion corresponding to the lead area between the first substrate and the second substrate. According to the parallel capacitance formula, it is known that C=εA/d, and the dielectric constant of the spacer layer is lower than that of liquid crystal layer. It can be seen that capacitance of the lead area is reduced, so that the overall capacitance at the circuit area will be effectively reduced after the setting, and thus to alleviate the problem that the resistance-capacitance load is too large.

Optionally, the circuit area is GOA circuit area.

In this embodiment, the step of forming the circuit area includes forming a driving area integrated with the gate driving chip function, and a lead area transmitting a signal of the driving area to a scanning line in the display area.

The spacer layer is disposed between the first substrate and the second substrate corresponding to the driving area and the lead area. Specifically, the spacer layer is disposed corresponding to the driving area and the lead area, a cross-sectional shape of the spacer layer corresponds to an overall shape of the driving area and the lead area. The capacitor of the circuit area includes a starting capacitor (Cd_com) and a gate-drain capacitance (Cgd), and the starting capacitor (Cd_com) is mainly present in the driving area, and the gate-drain capacitance (Cgd) is mainly present in the lead area. In the present invention, the spacer layer having a dielectric constant lower than that of the liquid crystal layer is provided at a portion corresponding to the driving area and the lead area between the first substrate and the second substrate. According to the parallel capacitance formula, it is known that C=εA/d, and the dielectric constant of the spacer layer is lower than that of liquid crystal layer. It can be seen that the capacitance of the driving area and the lead area are reduced, so that the overall capacitance at the circuit area will be effectively reduced after the setting, and thus to alleviate the problem that the resistance-capacitance load is too large.

In the above embodiment, the display panel includes a TN, an OCB, a VA type, and a curved liquid crystal display panel, but is not limited thereto.

When the display panel is a liquid crystal display panel, the spacer layer may be the same as the material of the spacer unit PS (Photo Spacer).

In this embodiment, optionally, a spacing support unit is further provided between the first substrate and the second substrate, the spacer layer and the spacing support unit are made of the same material by using the same process. With the same process to form and the same material is used to improve work efficiency.

Preferred embodiments of the present invention are described in detail above. It should be understood that those skilled in the art will be able to make many modifications and variations in accordance with the teachings of the present invention without making an inventive effort. Accordingly, those skilled in the art will, based on the teachings of the present invention, obtain a technical solution available through logical analysis, reasoning, or limited experimentation on the basis of prior art shall all fall within the protection scope of the claims.

What is claimed is:

1. A display panel, comprising:
a first substrate;
a second substrate comprising a color filter layer and disposed opposite to the first substrate; and
a liquid crystal layer disposed between the first substrate and the second substrate;
wherein
the first substrate comprises a circuit area and a display area;
the circuit area is formed with a spacer layer, a dielectric constant of the spacer layer is lower than a dielectric constant of the liquid crystal layer.

2. The display panel as claimed in claim 1, wherein the circuit area comprises:
a driving area integrated with a gate driving chip; and
a lead area for transmitting a signal of the driving area to a scanning line in the display area;
the dielectric material is disposed between the first substrate and the second substrate corresponding to the driving area.

3. The display panel as claimed in claim 2, wherein a cross-sectional shape of the spacer layer corresponds to a shape of the driving area.

4. The display panel as claimed in claim 2, wherein the spacer layer comprises a polystyrene material.

5. The display panel as claimed in claim 1, wherein the circuit area comprises:
a driving area integrated with a gate driving chip; and
a lead area for transmitting a signal of the driving area to a scanning line in the display area;
the spacer layer is disposed between the first substrate and the second substrate corresponding to the lead area.

6. The display panel as claimed in claim 5, wherein a cross-sectional shape of the spacer layer corresponds to a shape of the lead area.

7. The display panel as claimed in claim 5, wherein the spacer layer comprises a polystyrene material.

8. The display panel as claimed in claim 1, wherein the circuit area comprises:
a driving area integrated with a gate driving chip; and
a lead area for transmitting a signal of the driving area to a scanning line in the display area;
the spacer layer is disposed between the first substrate and the second substrate corresponding to the driving area and the lead area, respectively.

9. The display panel as claimed in claim 8, wherein a cross-sectional shape of the spacer layer corresponds to an overall shape of the driving area and the lead area.

10. The display panel as claimed in claim 8, wherein the spacer layer comprises a polystyrene material.

11. The display panel as claimed in claim 1, wherein a spacing support unit is further provided between the first substrate and the second substrate, and the spacer layer is made of a same material as the spacing support unit.

12. A method for manufacturing a display panel, the method comprising the steps of:
providing a first substrate;
providing a second substrate disposed opposite to the first substrate;
forming a color filter layer on the second substrate;
disposing a liquid crystal layer between the first substrate and the second substrate;
exposing a periphery of a display area of the first substrate to form a circuit area; and
disposing a spacer layer between the first substrate and the second substrate corresponding to the circuit area, wherein a dielectric constant of the spacer layer is lower than that of the liquid crystal layer.

13. The method for manufacturing the display panel as claimed in claim 12, wherein the step of forming the circuit area comprises forming a driving area integrated with a gate driving chip function and a lead area transmitting a signal of the driving area to a scanning line in the display area;
the spacer layer is disposed between the first substrate and the second substrate corresponding to the driving area.

14. The method for manufacturing the display panel as claimed in claim 13, wherein a cross-sectional shape of the spacer layer corresponds to a shape of the driving area.

15. The method for manufacturing the display panel as claimed in claim 12, wherein the step of forming the circuit area comprises forming a driving area integrated with a gate driving chip function and a lead area transmitting a signal of the driving area to a scanning line in the display area;
the spacer layer is disposed between the first substrate and the second substrate corresponding to the lead area.

16. The method for manufacturing the display panel as claimed in claim 15, wherein the spacer layer is disposed corresponding to the lead area, a cross-sectional shape of the spacer layer corresponds to a shape of the lead area.

17. The method for manufacturing the display panel as claimed in claim 12, wherein the step of forming the circuit area comprises forming a driving area integrated with a gate driving chip function and a lead area transmitting a signal of the driving area to a scanning line in the display area;
the spacer layer is disposed between the first substrate and the second substrate corresponding to the driving area and the lead area.

18. The method for manufacturing the display panel as claimed in claim 17, wherein the spacer layer is disposed corresponding to the driving area and the lead area, a cross-sectional shape of the spacer layer corresponds to an overall shape of the driving area and the lead area.

19. The method for manufacturing the display panel as claimed in claim 12, wherein a spacing support unit is further provided between the first substrate and the second substrate, the spacer layer and the spacing support unit are made of a same material by using a same process.

20. A display panel, comprising:
a first substrate;
a second substrate comprising a color filter layer and disposed opposite to the first substrate; and
a liquid crystal layer disposed between the first substrate and the second substrate;
wherein the first substrate comprises a circuit area and a display area;
the circuit area is formed with a spacer layer, a dielectric constant of the spacer layer is lower than a dielectric constant of the liquid crystal layer;
wherein the circuit area comprises:
a driving area integrated with a gate driving chip; and
a lead area for transmitting a signal of the driving area to a scanning line in the display area;
the spacer layer is disposed between the first substrate and the second substrate corresponding to the driving area and the lead area, respectively;
a spacing support unit is disposed between the first substrate and the second substrate, the spacer layer is made of a same material as the spacing support unit;
the spacer layer comprises a polystyrene material.
